(19) United States
(12) Patent Application Publication
(10) Pub. No.: US 2026/0081355 A1
(43) Pub. Date: Mar. 19, 2026

(54) ANTENNA WITH OPTIMIZED BEAM

(71) Applicant: Honeywell International Inc., Charlotte, NC (US)

(72) Inventors: Daniel Joseph Richardson, Prague (CZ); Petr Vitek, Brno (CZ)

(21) Appl. No.: 18/412,795

(22) Filed: Jan. 15, 2024

(51) Int. Cl. H01Q 9/04; H01Q 21/26

(52) U.S. Cl. CPC H01Q 9/0428; H01Q 21/26

(57) ABSTRACT

An antenna system comprising a circular polarized antenna a plurality of beam enhancers is provided. The plurality of beam enhancers may include a plurality of non-overlapping metal strips disposed around an axis of the circular polarized antenna, wherein the plurality of non-overlapping metal strips includes at least a first level of metal strips and at least a second level of metal strips, wherein the first level of metal strips is vertically offset from the second level of metal strips, and the first level of metal strips symmetrically arranged around the axis, wherein the first level of metal strips are separated by a second offset.

### TECHNICAL FIELD

The present application relates generally to antennas. More specifically, the present application relates generally to circular polarized antennas with optimized radiation beam.

### BACKGROUND

An antenna is a device that converts electrical signals into electromagnetic waves and vice versa, which allows for the transmission and reception of information wirelessly. Antennas often receive or transmit electromagnetic waves, for example to a satellite. Circular polarized antennas are configured to allow the antenna stay connected to the satellite even when the antenna faces in any direction.

Circular polarized antennas are used in various applications. In the ground plane (e.g., of particular applications), a circular polarized antenna requires a good axial ratio. Axial ratio is the ratio of vertical electric field component and the horizontal electric field component of the radiation. The optimum axial ratio on a circular polarized antenna is 0 (zero) dB in which the magnitude of the vertical electric field component and the horizontal electric field component magnitude are equal, hence producing a perfectly circular signal.

The inventors have identified numerous deficiencies and problems with the existing technologies in this field. For example, the axial ratio of circular polarized antenna may be impacted as the radiation pattern approaches the ground plane. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Various embodiments described herein relate to a circular polarized antenna with wide radiation beam and improved axial ratio. In general, embodiments of the present disclosure provided herein include provide for improved antennas.

In accordance with one aspect of the present disclosure, a circular polarized antenna system is provided. In some embodiments, the antenna system, includes a circular polarized antenna and a plurality of beam enhancers. The plurality of beam enhancers comprise a plurality of non-overlapping metal strips disposed around an axis of the circular polarized antenna, wherein the plurality of non-overlapping metal strips comprises at least a first level of metal strips and at least a second level of metal strips, wherein the first level of metal strips is vertically offset from the second level of metal strips, and the first level of metal strips symmetrically arranged around the axis, wherein the first level of metal strips are separated by a second offset.

In some embodiments, each metal strip of the plurality of non-overlapping metal strips has an arc shape.

In some embodiments, the plurality of non-overlapping metal strips have substantially the same arc length.

In some embodiments, the arc length of each metal strip of the plurality of non-overlapping metal strips is determined based on operating wavelength of the circular polarized antenna.

In some embodiments, the plurality of non-overlapping metal strips are disposed on a lower portion of the circular polarized antenna.

In some embodiments, the antenna system further comprises at least one tuner disposed above the circular polarized antenna, wherein the at least one tuner comprises a plurality of extending arms symmetrically oriented around the circular polarized antenna, wherein the plurality of extending arms are formed of a metal material.

In accordance with another aspect of the present disclosure, an antenna system is provided. In some embodiments, the antenna system includes a circular polarized antenna; a plurality of beam enhancers symmetrically arranged around the circular polarized antenna; and at least one tuner disposed above the circular polarized antenna, wherein the at least one tuner comprises a plurality of extending arms symmetrically oriented around the circular polarized antenna, wherein the plurality of extending arms are formed of a metal material.

In some embodiments, the plurality of beam enhancers includes a plurality of non-overlapping metal strips disposed around an axis of the circular polarized antenna.

In some embodiments, each metal strip of the plurality of non-overlapping metal strips has an arc shape.

In some embodiments, the plurality of non-overlapping metal strips have substantially the same arc length.

In some embodiments, the plurality of extending arms radially extend across the antenna system and cause a detuning effect of a body attached to the antenna system.

In some embodiments, the plurality of extending arms define a cross shape.

In accordance with another aspect of the present disclosure, a circular polarized antenna is provided. In some embodiments, the circular polarized antenna includes a plurality of antenna elements; and a plurality of beam enhancers, the plurality of beam enhancers comprising a plurality of non-overlapping metal strips disposed around the plurality of antenna elements wherein the plurality of non-overlapping metal strips comprises at least a first level of metal strips and at least a second level of metal strips, wherein the first level of metal strips is vertically offset from the second level of metal strips, and the first level of metal strips symmetrically arranged around the plurality of antenna elements, wherein the first level of metal strips are separated by a second offset.

In some embodiments, each metal strip of the plurality of non-overlapping metal strips has an arc shape.

In some embodiments, the plurality of non-overlapping metal strips have substantially the same arc length.

In some embodiments, the arc length of each metal strip of the plurality of non-overlapping metal strips is determined based on operating wavelength of the circular polarize antenna.

In some embodiments, the plurality of non-overlapping metal strips are disposed on a lower portion of the plurality of antenna elements.

In some embodiments, the circular polarized antenna further includes at least one tuner disposed above the plurality of antenna elements, wherein the at least one tuner comprises a plurality of extending arms symmetrically oriented around the plurality of antenna elements, wherein the plurality of extending arms are formed of a metal.

In some embodiments, the plurality of extending arms radially extend across the circular polarized antenna and cause a detuning effect of a body attached to the circular polarized antenna.

In some embodiments, the plurality of extending arms define a cross shape.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides a perspective view of a circular polarized antenna, in accordance with at least one example embodiment of the present disclosure.

FIG. 2 provides an exploded view of a circular polarize antenna in accordance with at least one example embodiment of the present disclosure.

FIG. 3 provides a perspective view of a portion of a circular polarized antenna showing beam enhancers in accordance with at least one example embodiment of the present disclosure.

FIGS. 4A-4C provide different views of an example beam enhancer in accordance with at least one example embodiment of the present disclosure.

FIG. 5A provides a perspective view of a portion of a circular polarized antenna showing a tuner in accordance with at least one example embodiment of the present disclosure.

FIGS. 5B-5D provide different views of an example tuner in accordance with at least one example embodiment of the present disclosure.

FIG. 6A provides an example plot of an antenna gain in the receive band in accordance with at least one example embodiment of the present disclosure.

FIG. 6B provides an example plot of an antenna gain in the transmit band in accordance with at least one example embodiment of the present disclosure.

FIG. 6C provides an example plot of axial ratio in the receive band in accordance with at least one example embodiment of the present disclosure.

FIG. 6D provides an example plot of axial ratio in the transmit band in accordance with at least one example embodiment of the present disclosure.

FIG. 7A provides an example plot of an antenna gain in the receive band in accordance with at least one example embodiment of the present disclosure.

FIG. 7B provides an example plot of an antenna gain in the transmit band in accordance with at least one example embodiment.

FIG. 7C provides an example plot of axial ratio in the receive band in accordance with at least one example embodiment of the present disclosure.

FIG. 7D provides an example plot of axial ratio in the transmit band in accordance with at least one example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “electrical communication” means that an electric current and/or electric signals are capable of making the connection between the areas specified.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, terms of approximation, such as “approximately,” “substantially,” or “about,” refer to being within manufacturing or engineering tolerances. For example, terms of approximation may refer to being withing a five percent margin of error.

An antenna may be configured to receive or to transmit electromagnetic waves. When two or more antennas are used, the electromagnetic waves can create a communication link between the two or more antennas provided there is sufficient power. If the antennas are fixed in one position, the electromagnetic waves can be directed to form a beam. This beam optimizes the energy in a specific direction to maintain the link, thus directs the energy to the other antenna. The amount of energy at the position may be described as the gain of the antenna. In some cases, the antenna may not be fixed, so the beam may need to be dynamically positioned or steered to maintain the connection (e.g., link). If the beam is sufficiently wide, the movement of the antenna would not affect the link providing the power and the communication link is maintained. The wider the beam, the more positions the antenna can be orientated while maintaining a link. For example, in an aircraft environment, an antenna with a wide beam is optimal since the link would be maintained during the different maneuvers. In various applications, an antenna with a beam that covers all angles over the horizon is desired.

As described above, a circular polarized antenna requires a good axial ratio (e.g., the ratio of vertical electric field component and the horizontal electric field component of the radiation). The axial ratio of a circular polarized antenna may describe how circular the beam is. For example, the lower the axial ratio, the more circular the beam. A circular polarized antenna in particular applications may require a good axial ratio everywhere above the horizon from the zenith (directly overhead) to very low elevation angles near the horizon. The axial ratio of circular polarized antenna may be impacted as the radiation pattern approaches the ground plane. For example, the axial ratio of a circular polarize antenna may be impacted as the radiation pattern approached the ground plane due to one of the vertical electric field component or horizontal electric field component of the radiation collapsing as the radiation approaches the ground plane.

Moreover, in some applications, an antenna may be coupled to a body, for example onboard a particular vehicle, that causes the antenna to detune. The body, for example, may be a moveable machine, vehicle, and/or the like, such as an aircraft (e.g., airplane, helicopter, and/or the like), a rotorcraft, an unmanned aerial vehicle (UAV), a watercraft (e.g., ship, boat, and/or the like), a land vehicle, and/or the like. The body coupled to the antenna may interact with the radiation and cause the antenna to detune in a particular manner.

Embodiments of the present disclosure address the above-mentioned challenges and difficulties, as well as other challenges and difficulties associated with circular polarized antennas. Specifically embodiments of the present disclosure provide a circular polarized antenna with optimized radiation beam and axial ratio. Example embodiments of the present disclosure provide a circular polarized antenna that achieves a wider radiation beam and improved axial ratio upon being positioned, whether directly or indirectly, between or on at least one body. Some embodiments of the present disclosure include a plurality of beam enhancer elements positioned in a particular configuration to increase the width of the radiation beam and the axial ratio of the radiation beam. The plurality of beam enhancers are configured to improve the gain and the axial ratio. For example, the plurality of beam enhancers are configured to enhance a component of the radiation beam (e.g., vertical electric field component or horizontal electric field component of the radiation beam) such that the magnitude of the component substantially matches the opposite component, which in turn reduces the axial ratio.

Some embodiments of the present disclosure additionally include at least one specially configured tuner configured to counteract detuning effects of a body attached to the circular polarized antenna. For example, the at least one specially configured tuner may be configured to retune a circular polarized antenna when the antenna is detuned.

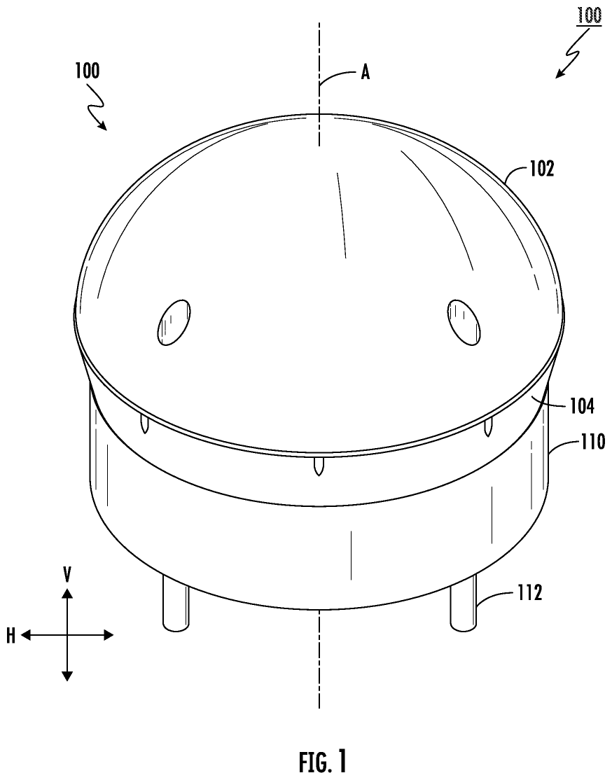

FIG. 1 provides a perspective view of an example circular polarized antenna 100 in accordance with at least one example embodiment. Specifically, FIG. 1 provides a perspective view of an example circular polarized antenna in which beam enhancer(s) and/or tuner(s) according to at least some example embodiments of the present disclosure may be utilized. It would be appreciated that the beam enhancer(s) and/or tuner(s) may be utilized in other circular polarized antennas having different configurations compared to the illustrated example circular polarized antenna 100.

The antenna 100 may be defined based at least in part on a vertical direction V and a horizontal direction H. Additionally, the antenna 100 may define a vertical axis A that extends through a center of the antenna 100. In some embodiments, the antenna 100 is configured as a hemispheric antenna, such as an L-band hemispheric antenna. As shown in FIG. 1, the antenna 100 may include a radome top 102 that is coupled, directly or indirectly, to a radome base 104. The radome base 104 may be coupled, directly or indirectly, to an antenna base 110. In some embodiments, the antenna 100 includes a plurality of standoffs 112 configured to facilitate coupling of the antenna 100 to a structure (e.g., a building), a vehicle (e.g., an aircraft, a seacraft, or a land vehicle), or equipment. Each standoff 112 may be coupled, directly or indirectly, to the antenna base 110.

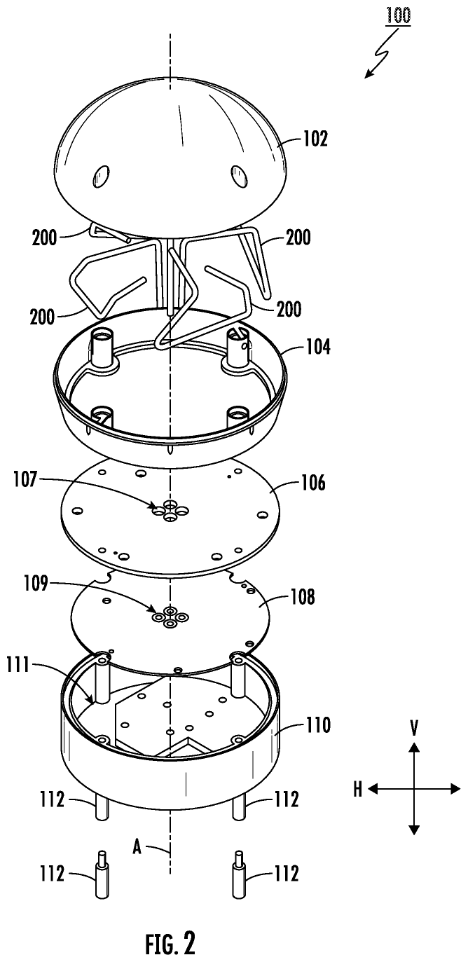

FIG. 2 is an exploded view of an example circular polarized antenna 100 showing portions of the antenna 100 in accordance with at least one example embodiment of the present disclosure. The antenna 100 may include a plurality of antenna elements 200. In some embodiments, the antenna elements 200 comprise a plurality of wires. For example, each of the plurality of antenna elements 200 may be configured as antenna wires that are configured to receive and/or transmit electromagnetic waves. Each of the plurality of antenna elements 200 may be positioned at different circumferential points around the vertical axis A defined by the antenna 100. In various examples, each of the plurality of antenna elements 200 may be separate, discrete antenna elements 200 that are positioned substantially equidistant from adjacent antenna elements 200. For example, each of the plurality of antenna elements 200 may comprise separate, discrete antenna wires that are positioned substantially equidistant from adjacent wires. For example, and as depicted in FIG. 2, the antenna 100 includes four discrete antenna elements 200 (e.g., four discrete wires) that are spaced approximately ninety degrees from each other. (e.g., within a two-degree tolerance or the like).

Each of the plurality of antenna elements 200 can be configured substantially the same (e.g., within manufacturing or engineering tolerances). For example, the shape and material may be the same. The pose of each of the antenna elements 200 may be different, however. For example, and as depicted in FIG. 2, each of the antenna elements 200 may be rotated approximately ninety degrees relative to adjacent antenna elements 200. Each of the antenna elements 200 can comprise a conductive material, such as a metal, at least on a surface of the antenna elements 200. For example, at least a surface of each of the antenna elements 200 can comprise copper, steel, a combination thereof, and/or the like. For example, each of the antenna elements 200 can comprise steel (e.g., a low-carbon steel) that is plated with copper. In some embodiments, each of the antenna elements 200 may have a bent configuration. For example, each of the antenna elements 200 may comprise wires having a bent wire configuration. It should be understood, that in some embodiments, the antenna elements 200 may comprise other configuration.

Each of the antenna elements 200 may be positioned at least partially within the radome top 102 and at least partially within the radome base 104. In some embodiments, the radome top 102 is shaped like a hemisphere. The radome top 102 may have a concave interior, such that each of the antenna elements 200 may be at least partially positioned within the radome top 102. The radome top 102 may comprise material that is substantially transparent to radio frequent (RF) signals such as plastic, polyethylene, and/or the like. For example, the radome top 102 can be formed or otherwise manufactured from material that is substantially transparent to RF signals. The radome top 102 may be configured to cover at least a portion of the antenna elements 200 and/or protect at least a portion of the antenna elements 200 from the environment (e.g., rain, snow, and/or the like.).

The radome base 104 may be generally cylindrical shaped and each of the antenna elements 200 may be at least partially positioned within. The radome base 104 may comprise material that is substantially transparent to RF signals such as plastic, polyethylene, and/or the like. For example, the radome base 104 may be formed or otherwise manufactured from material that is substantially transparent to RF signals. The radome base may be configured to cover at least a portion of the antenna elements 200 and/or protect at least a portion of the antenna elements 200 from the environment (e.g., rain, snow, and/or the like.). The radome base 104 may be configured to mechanically support the antenna elements 200. Additionally or alternatively, the random base may be configured to prevent vibration from being transferred to the antenna elements 200.

In some embodiments, the antenna 100 includes a ground plane 106. The ground plane 106 may define a plurality of openings 107. The antenna elements 200 elements may be configured to extend through a corresponding opening 107 of the ground plane 106. The ground plane 106 may be configured as a ground connection for the RF source.

In some embodiments, the antenna 100 includes a splitter 108. The splitter 108 may include a plurality of antenna connections 109. Each of the antenna elements 200 may be coupled to a corresponding antenna connection 109 of the splitter 108. For example, each of the antenna elements 200 may be soldered to the corresponding antenna connection 109 of the splitter 108 or otherwise coupled to the corresponding antenna connection 109.

In some embodiments, the antenna base 110 may be substantially cylindrical shaped. In some embodiments, the antenna base may define a cavity 111 configured to house various electronic components of the antenna 100. For example, the antenna 100 may include various electronic components, such as a transmitter, a receiver, and/or the like. The transmitter, receiver, and/or other electronic components may be housed within the cavity 111 of the antenna base 110. Each of the antenna elements 200 may be in electrical communication with the transmitter and/or receiver. In some embodiments, each of the antenna elements 200 is in electrical communication with the transmitter and/or the receiver through a corresponding antenna connection 109 of the splitter 108. In some embodiments, each of the antenna elements 200 may be in electrical communication with one or more other electronic components of the antenna 100.

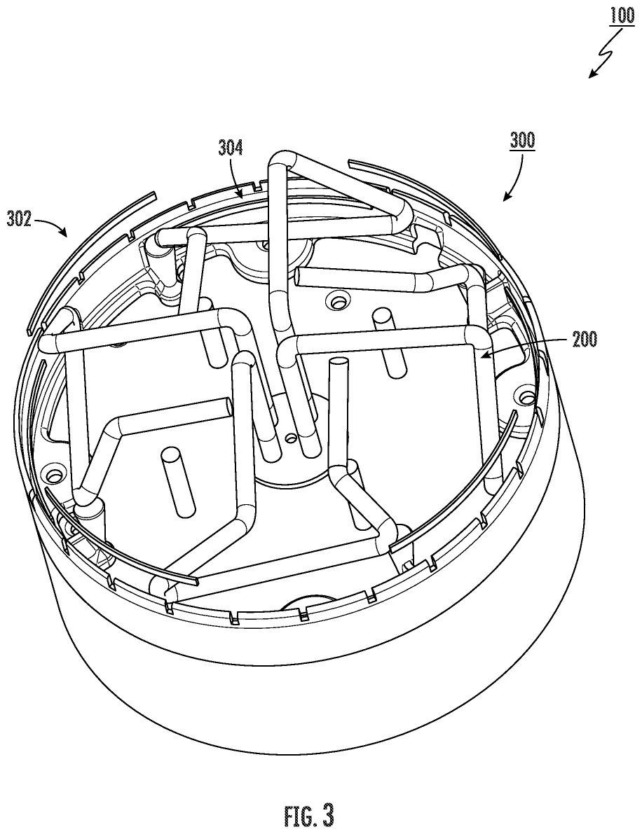

FIG. 3 provides a perspective view of a portion of the antenna 100 showing beam enhancers in accordance with at least one example embodiment of the present disclosure. Specifically FIG. 3 shows the antenna elements 200 and beam enhancers according to at least some example embodiments of the present disclosure. As described herein, the antenna elements 200 may comprise steel, such as a low-carbon steel, and/or copper. For example, the antenna elements 200 may be made of steel wire plated with copper. In some examples, the diameter of the antenna elements 200 is within a range of 3.4 mm to 3.4 mm. In some example, the diameter of the antenna elements 200 is within a range of 2 mm to 6 mm. However, it would be appreciated that the antenna elements 200 can be any suitable diameter.

The antenna elements 200 may include a plurality of straight portions. As used herein, the term “straight portion” refers to a length of an antenna element 200 that extends substantially in only one direction, such as, for example, within five degrees, such as within three degrees, such as within one degree of the only one direction. As described herein, the antenna elements 200 may have a bent configuration such that the antenna elements 200 include a plurality of curved portions. Each of the curved portions may be defined between and/or connect adjacent straight portions. For example, a first curved portion may be defined between and/or connect the first straight portion with a second straight portion. As another example, a second curved portion may be defined between and/or connect the second straight portion and a third straight portion, and so forth. In some embodiments, the antenna elements 200, including the plurality of straight portions and the plurality of curved portions is continuous. For example, the straight portions and the curved portions may be monolithic. Each curved portion may connect two adjacent straight portions.

As described herein, the antenna 100 includes a plurality of beam enhancers disposed around the vertical axis (e.g., vertical axis A) of the antenna 100. Specifically, the plurality of beam enhancers may be disposed around the plurality of antenna elements 200 of the antenna 100 such that the beam enhancers are positioned around the vertical axis defined by the antenna 100. In various embodiments, the plurality of beam enhancers is configured to optimize the width of the radiation beam of the antenna 100 and the axial ratio of the radiation beam. Specifically, the plurality of beam enhancers is configured to allow for providing a circular polarized antenna 100 having a wide radiation beam and improved axial ratio.

In various embodiments, each beam enhancer comprises a metal strip such as, for example, a metal plate. In this regard, in various embodiments, and as shown in FIG. 3, the antenna 100 comprises a plurality of metal strips 300 disposed around the vertical axis of the antenna 100 to optimize the width of the radiation beam of the antenna 100 and the axial ratio of the radiation beam. For example, the plurality of metal strips may be positioned within the radome of the antenna 100 and arranged around the antenna elements of the antenna 100. In various embodiments, each of the plurality of metal strips 300 is positioned at different circumferential points around the vertical axis, such that the beam metal strips do not overlap with each other. Each metal strip may be configured to affect the beam in the direction the metal strip is located.

In various embodiments, the plurality of metal strips 300 are arranged in one or more levels. In some embodiments, the plurality of metal strips 300 comprise at least a first level of metal strips and at least a second level of metal strips. As shown in FIG. 3, the plurality of metal strips comprises a first level of metal strips 302 and a second level of metal strips 304. Each level of metal strip is vertically offset with respect to the other level(s). For example, as shown in FIG. 3, the first level of metal strips 302 is vertically offset from the second level of metal strips 304. The first level of metal strips 302 is symmetrically arranged around the center axis with each metal strip of the first level of metal strips 302 separated from each other. For example, each metal strip of the first level of metal strips 302 may be horizontally offset from each other. The second level of metal strips 304 is symmetrically arranged around the center axis with each metal strip of the second level of metal strips 304 separated from each other. For example, each metal strip of the second level of metal strips 304 may be horizontally offset from each other. In some embodiments, the plurality of metal strips 300 (e.g., non-overlapping metal strips) are disposed on a lower portion of the circular polarized antenna. For example, the first level of metal strips 302 and the second level of metal strips 304 may be positioned around the antenna elements 200 and on a lower portion thereof. By way of non-limiting example, the second level of metal strips 302 may be placed around the antenna elements of the antenna 100 at 90 degrees from each other, and the first level of metal strips 302 may be placed around the antenna elements of the antenna 100 at 45 degrees relative to the second level of metal strips 302.

Each of the plurality of metal strips 300 may comprise copper, aluminum, steel, and/or other metal materials. For example, each of the plurality of metal strips 300 may be made from copper, aluminum, steel, and/or other metal materials. In one particular example embodiment, each of the plurality of metal strips 300 comprise a copper sheet.

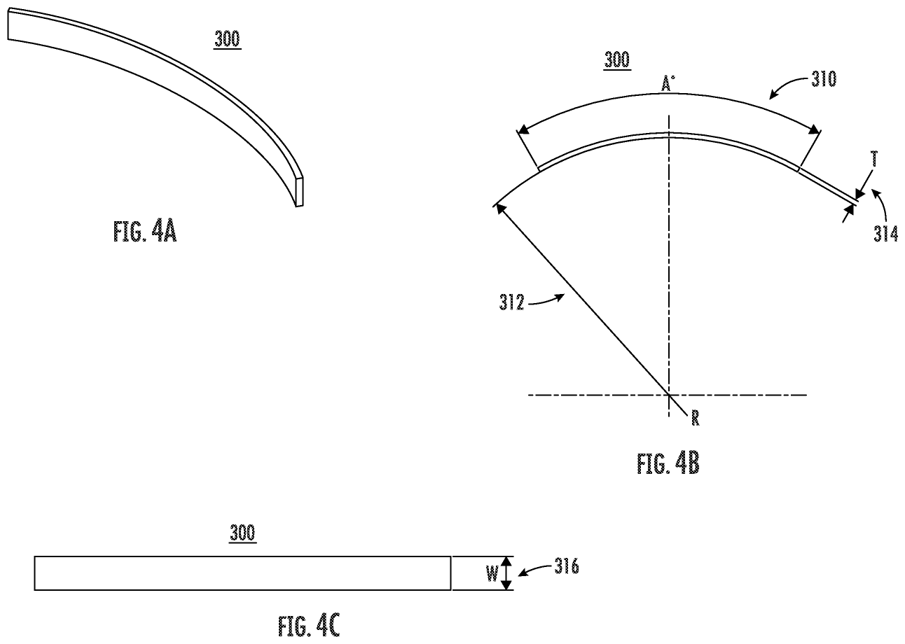

FIGS. 4A-4C provide different views of an example beam enhancer (e.g., embodied as a metal strip 300) in accordance with at least one example embodiment of the present disclosure. As shown in FIGS. 4A and 4B, the example metal strip 300 may have a curved shape. For example, the example metal strip 300 may have an arc shape. In various embodiments, each of the plurality of metal strips 300 has an arc shape. As shown in FIGS. 4A-C, the example metal strip 300 may have an arc length 310 (e.g., arc length “A”), a radius of curvature 312 (e.g., radius of curvature “R”), a thickness 314 (e.g., thickness “T”), and a width 316 (e.g., width “W”).

In some embodiments, one or more dimensions of the example metal strip 300 (e.g., beam enhancer) is based on the wavelength on which the antenna 100 is operating. For example, in some embodiments, each of the metal strips 300 may have an arc length that is determined based on the operating wavelength of the antenna 100. By way of example, a beam enhancer (e.g., metal strip 300) of an example circular polarized antenna operating at 1.5GHz and having a wavelength of about 19 cm may be 22 mm. The arc length of a metal strip 300 may have an inverse relationship with respect to the frequency. For example, the length of a metal strip 300 may be selected based on the operating frequency of the antenna 100.

In some embodiments, the example metal strip 300 has a preferred thickness in the range 0.01 mm to 1 mm. In an example embodiment, the example metal strip 300 has a thickness of about 0.035 mm. It would be appreciated that in some other embodiments, the example metal strip 300 may have a thickness that is less than 0.01 mm or greater than 1 mm. The example metal strip 300, for example, may comprise a thin metal strip. In some embodiments, the example metal strip 300 has a width that is greater than the thickness of the example metal strip 300. In some embodiments, the example metal strip 300 may have a width that is less than or substantially the same as the thickness of the example metal strip 300.

In some embodiments, the plurality of metal strips 300 have substantially the same arc length. One or more other dimensions of the metal strips 300 may be the same across the plurality of metal strips 300. In some embodiments, the plurality of metal strips 300 may have substantially the same thickness. Alternatively or additionally, in some embodiments, the plurality of metal strips 300 may have substantially the same radius of curvature. Alternatively or additionally, in some embodiments, the plurality of metal strips 300 may have substantially the same width. In an example embodiment, the thickness of each of the plurality of metal strips 300 are substantially the same, the width of each of the plurality of metal strips 300 are substantially the same, and the arc length of each of the plurality of metal strips 300 are substantially the same. In such example embodiment, having the same thickness, the same width, and the same arc length provides symmetricity to the beam. It would be appreciated that in some embodiments, one or more dimensions of the metal strips may be different across the plurality of metal strips 300. For example, one or more of the plurality of metal strips 300 may have different thicknesses. As another example, one or more of the plurality of metal strips 300 may have different widths. As yet another example, one or more of the plurality of metal strips 300 may have different arc lengths. In some embodiments, one or more dimensions of the metal strips 300 may be configured to be different across the plurality of metal strips 300 to modify the beam in certain direction(s).

As described above, in some embodiments, the plurality of non-overlapping metal strips 300 (e.g., beam enhancers) are disposed on a lower portion of the antenna 100. The configuration of the beam enhancers including, for example, placing the beam enhancers on a lower portion of the antenna 100 improves beam width and axial ratio on the lower elevation as well as the upper elevation (e.g., when desired).

As described herein, the plurality of metal strips 300 are arranged in a particular configuration to optimize the antenna 100. For example, the plurality of metal strips 300 are configured to improve (e.g., increase) the beam width of the radiation beam of the antenna 100. Additionally, the plurality of metal strips 300 are configured to improve (e.g., reduce) the axial ratio of the radiation beam. The metal strips 300 are configured to pull the radiation beam of the antenna 100 in the direction in which the metal strip 300 is placed, which increases the beam width. For example, the beam enhancers comprising the metal strips 300 are configured to resonate. As the beam enhancers resonate and interact with the energy, they pull the radiation beam in that direction. For example, the plurality of beam enhancers comprising the metal strips 300 are energized by the radiation beam, which causes the beam enhancers comprising the metal strips 300 to fold the radiation beam in the direction in which the plurality of beam enhancers comprising the metal strips 300 are placed. For example, a metal strip 300 may fold the beam in a direction that is perpendicular to the shape (e.g., arc shape) of the metal strip towards the center axis.

In various embodiments, the plurality of beam enhancers comprising the metal strips 300 are configured to increase the beam width at lower elevations and/or at higher elevations. Additionally, as described above, the plurality of beam enhancers comprising the metal strips 300 may be configured correct for axial or linearization of the beam to make the beam more circular. For example, the plurality of beam enhancers comprising the metal strips 300 may optimize the beam width of the antenna 100 by increasing the beam width of the antenna 100, as well as improving the axial ratio with respect to the antenna patterns (e.g., improving circular polarization of the antenna 100).

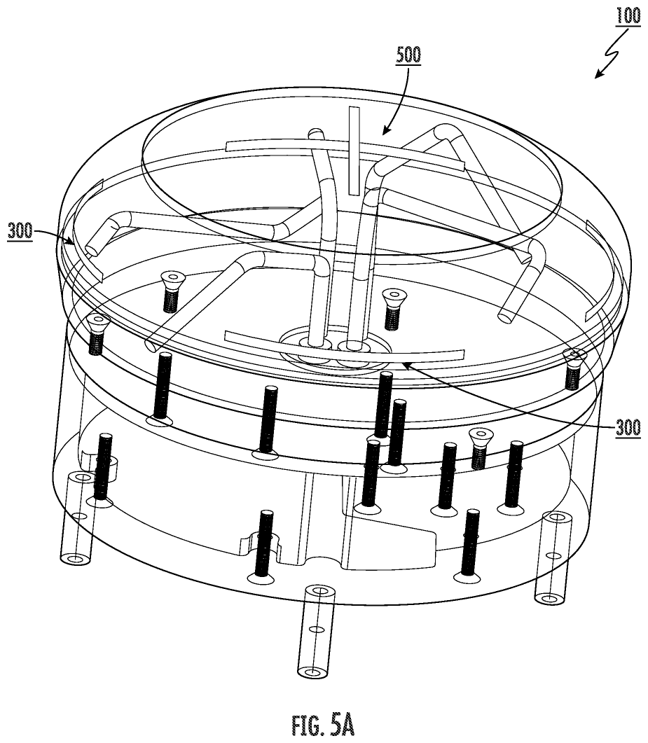

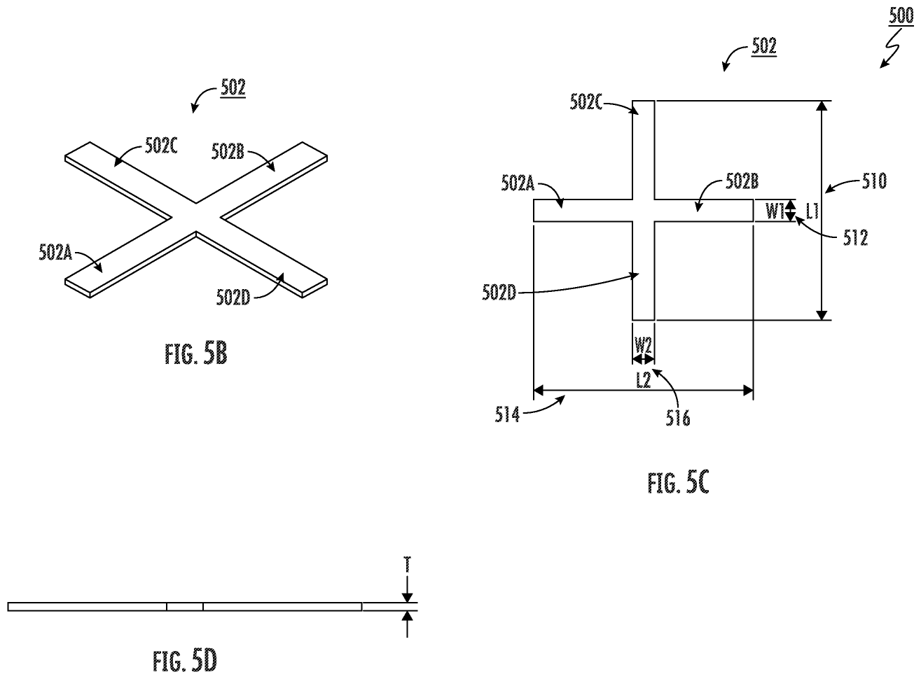

FIG. 5A is a perspective view of a portion of the antenna 100 showing a tuner 500 according to at least one embodiment of the present disclosure. In some embodiments, the antenna 100 includes at least one tuner configured to counteract one or more detuning effects caused at least in part by a body attached to the antenna 100. For example, the antenna 100 may be coupled to a moveable machine such as, for example an aircraft (e.g., airplane, helicopter, and/or the like), a rotorcraft, an unmanned aerial vehicle (UAV), a watercraft (e.g., ship, boat, and/or the like), a land vehicle, and/or the like. A body coupled to the antenna 100 may interact with the radiation, for example, on the lower elevation levels in particular. The interaction of the body with the radiation may cause the antenna 100 to detune.

FIGS. 5B-5D provide different views of an example tuner 500 in accordance with at least one example embodiment of the present disclosure. The tuner 500 may be configured to counteract the detuning effect of the body. In various embodiments, the tuner 500 is disposed above the antenna elements 200 of the antenna 100. In various embodiments, the tuner 500 is positioned in the center (e.g., zenith position) inside the radome to retune the antenna and improve the axial ratio, while maintaining the desired beam width. In various embodiments, and as shown in FIGS. 5B and 5C, the tuner 500 comprises a plurality of extending arms 502. In various embodiments, the plurality of extending arms 502 is symmetrically oriented around the circular polarized antenna.

In some embodiments, and as shown in FIGS. 5B and 5C, the plurality of extending arms 502 may comprise four extending arms 502A-D that collectively define a cross shape. For example, the tuner 500 may have a substantially cross-shape. The plurality of extending arms 502 may comprise opposing pairs of extending arms. In some embodiments, and as shown in FIG. 5B, the plurality of extending arms 502 comprises a first pair of extending arms 502A and 502B and a second pair of extending arms 502C and 502D. In various embodiments, each extending arm of the first pair of extending arms 502A and 502B has a length 510 (e.g., Length “L1”) and a width 512 (e.g., width “W1”). In various embodiments, each extending arm of the second pair of extending arms 502C and 502D a length 514 (e.g., Length “L2”) and a width 516 (e.g., width “W1”). In some embodiments, the length 510 and length 514 are substantially the same. In some embodiments, the length 510 and length 514 are different. In some embodiments, the width 512 and width 516 are substantially the same. In some embodiments, the width 512 and width 516 are substantially the same. In an example embodiment, the dimensions of each of the plurality of extending arms 502 are configured to be the same to provide symmetricity to the beam. For example, the length of each of the plurality of extending arms may be the same and the width of each of the plurality of extending arms may be the same. It would be appreciated that in some embodiments, the widths and/or lengths of one or more of plurality of extending arms 502 may be different. In some embodiments, the length of the extending arms depend on the length and/or placement of the metal strips.

In various embodiments, the plurality of extending arms 502 may be formed from metal material. The plurality of extending arms 502 may comprise copper, aluminum, steel, and/or other metal materials. For example, each of the plurality of extending arms 502 may be made from copper, aluminum, steel, and/or other metal materials. In one particular example embodiment, each of the plurality of extending arms 502 comprise a copper sheet. In some embodiments, the plurality of extending arms 502 are integrally formed. For example, the plurality of extending arms 502 may be monolithic. It would be appreciated that in some embodiments, the plurality of extending arms may not be integrally formed. For example, the plurality of extending arms may not be monolithic in some embodiments.

The plurality of extending arms 502 may radially extend across the circular polarized antenna. For example, the plurality of extending arms 502 may radially extend across the antenna elements 200 of the circular polarized antenna 100. In some embodiments, each extending arm of the tuner 500 has a length that is substantially the same as the arc length of the beam enhancers comprising metal strips 300. For example, each extending arm of the tuner 500 has a length that is substantially the same as the arc length of the metal strips 300. As described above, the tuner 500 may be configured to cause a detuning effect of a body, such as a moveable machine, coupled to the antenna 100.

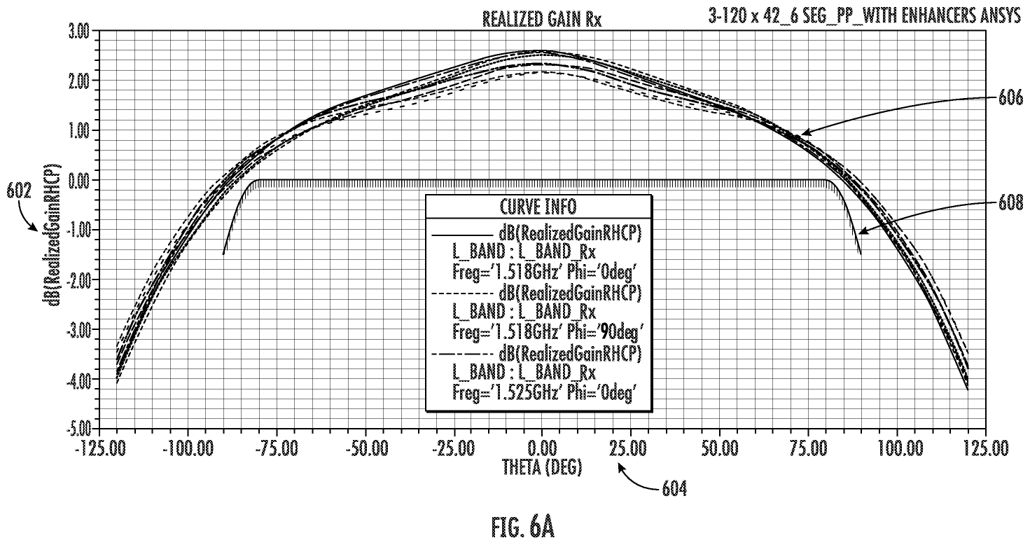

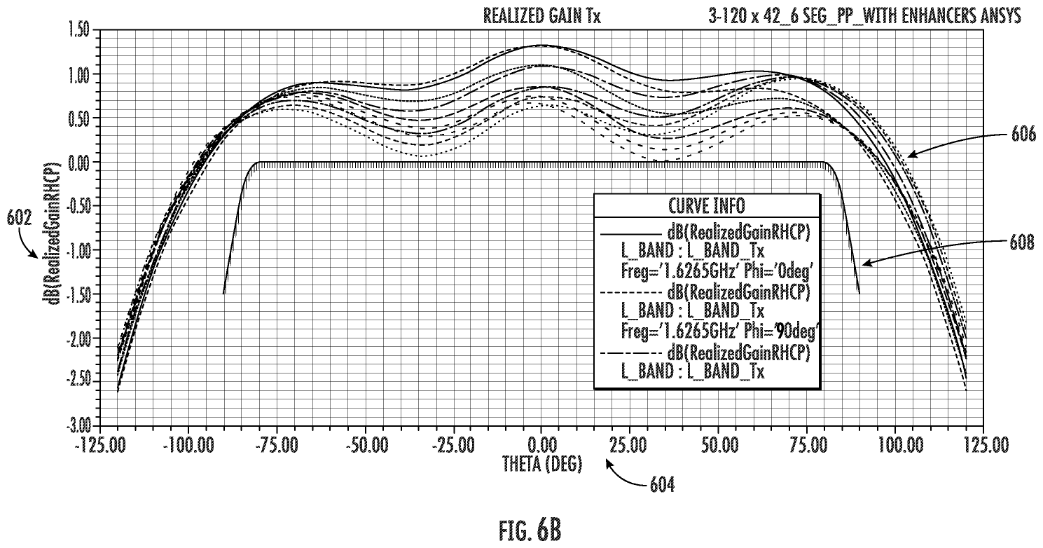

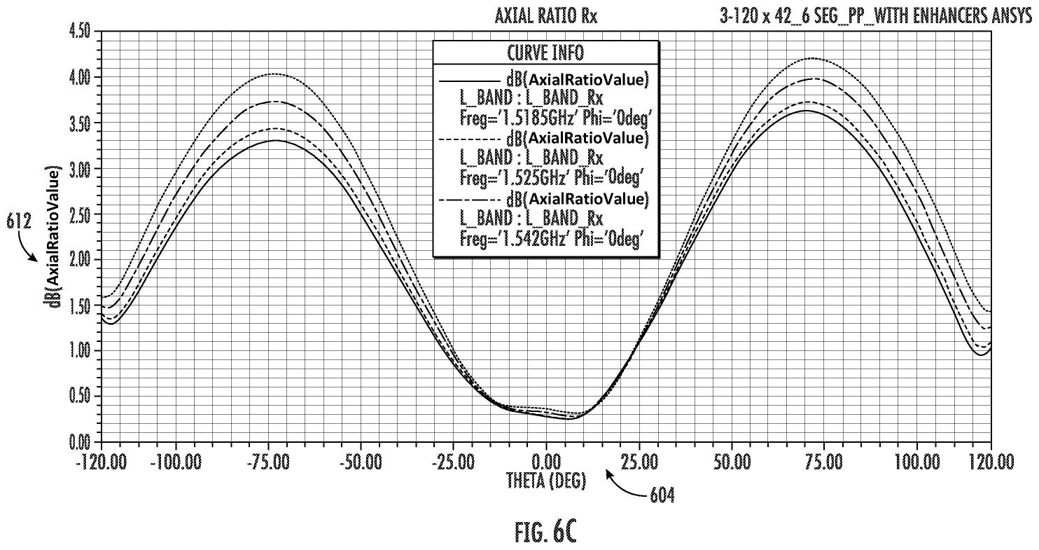

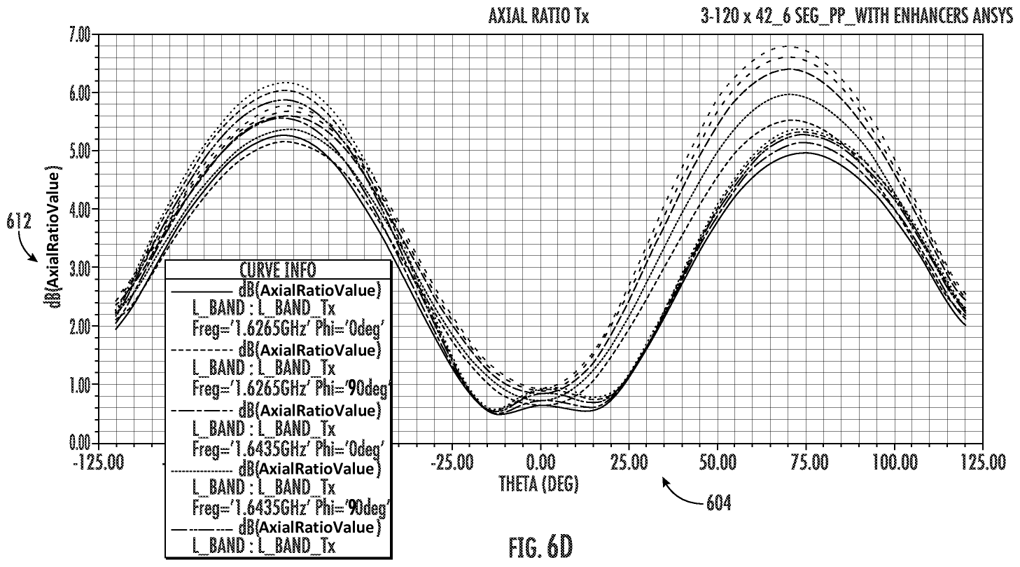

FIG. 6A provides an example plot of an antenna gain in the receive (Rx) band in accordance with at least one example embodiment of the present disclosure. FIG. 6B provides an example plot of an antenna gain in the transmit (Tx) band in accordance with at least one example embodiment of the present disclosure. FIG. 6C provides an example plot of axial ratio in the receive band in accordance with at least one example embodiment of the present disclosure. FIG. 6D provides an example plot of axial ratio in the transmit band in accordance with at least one example embodiment of the present disclosure. Specifically, FIGS. 6A-6D provide example plots of antenna gain and axial ratio of a circular polarized antenna having a plurality of beam enhancers comprising beam enhancers such at the metal strips 300 disposed around an axis of the antenna (e.g., positioned around antenna elements of the circular polarized antenna). The example plot of FIGS. 6A-6D illustrate an example antenna gain of an example circular polarized antenna without a tuner. As shown in FIGS. 6A-6B, the example antenna gain plots depict the antenna gain represented on the Y-axis 602 in decibel (db) as a function of the elevation angle represented on the X-axis 604 in degrees. As shown in FIGS. 6C-6D, the example axial ratio plots depict the axial ratio represented on the Y-axis 612 in decibel (db) as a function of the elevation angle represented on the X-axis 604 in degrees.

As shown in FIGS. 6A and 6B, the beam enhancers comprising metal strips 300 pull the radiation beam 606 in the direction in which the metal strip 300 is placed, which increases the beam width such that it satisfies a predetermined and/or desired beam width threshold 608 for each band. As described above, the plurality of metal strips 300 are energized by the radiation beam, which causes the metal strips 300 to fold the beam in the direction in which the plurality of metal strips are placed (e.g., e.g., perpendicular to the arc shape of the metal strips 300 towards the center axis defined by antenna elements 200). As shown in FIGS. 6C and 6D, the metal strips 300 improve the axial ratio. For example, the metal strips 300 may improve the axial ratio based on the metal strips influence on the e-field components, which reduces the difference between the components.

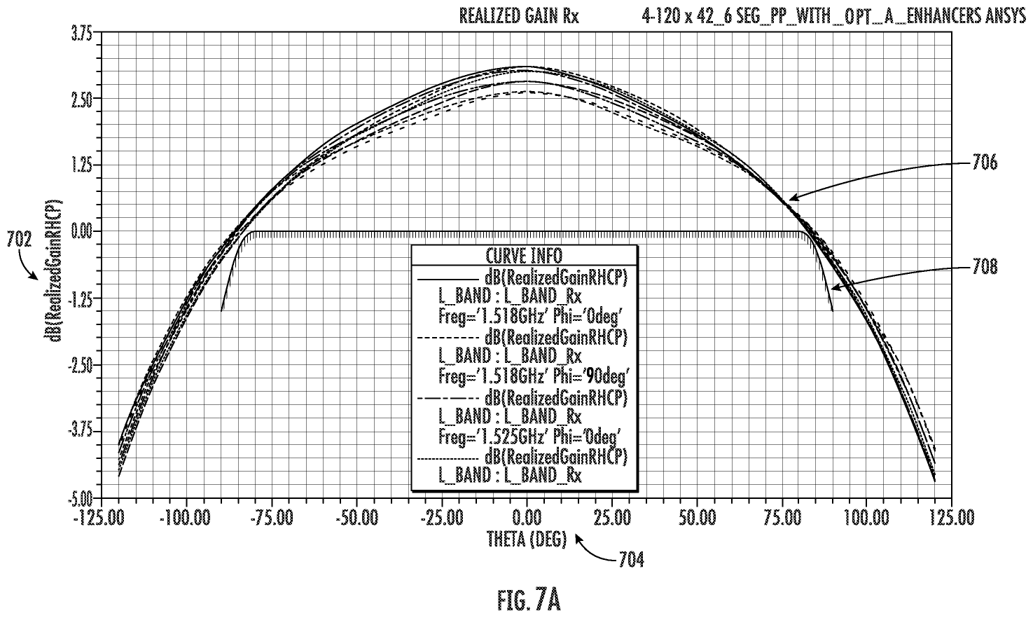

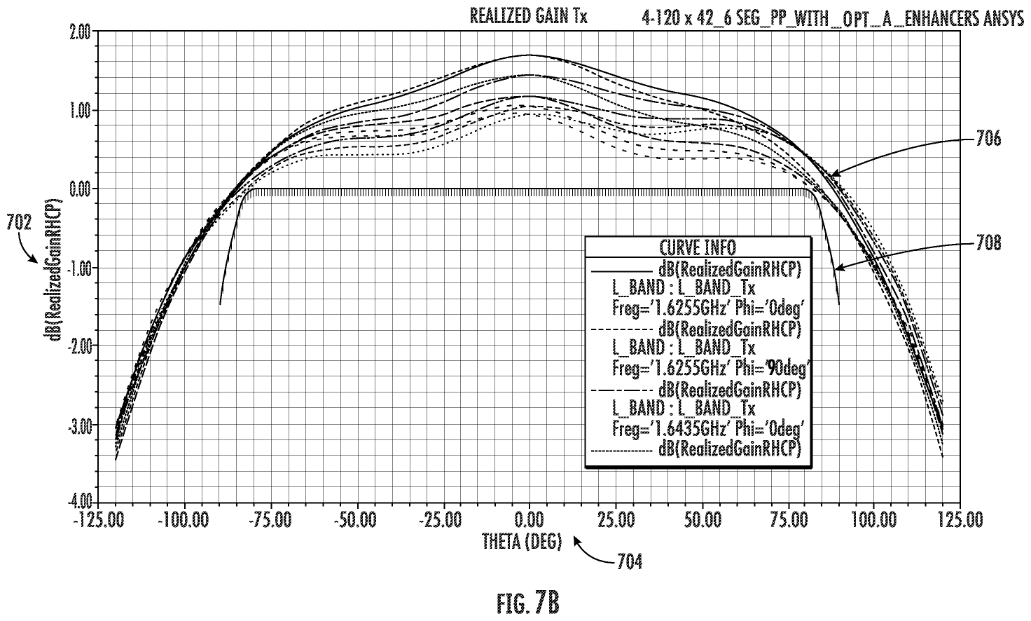

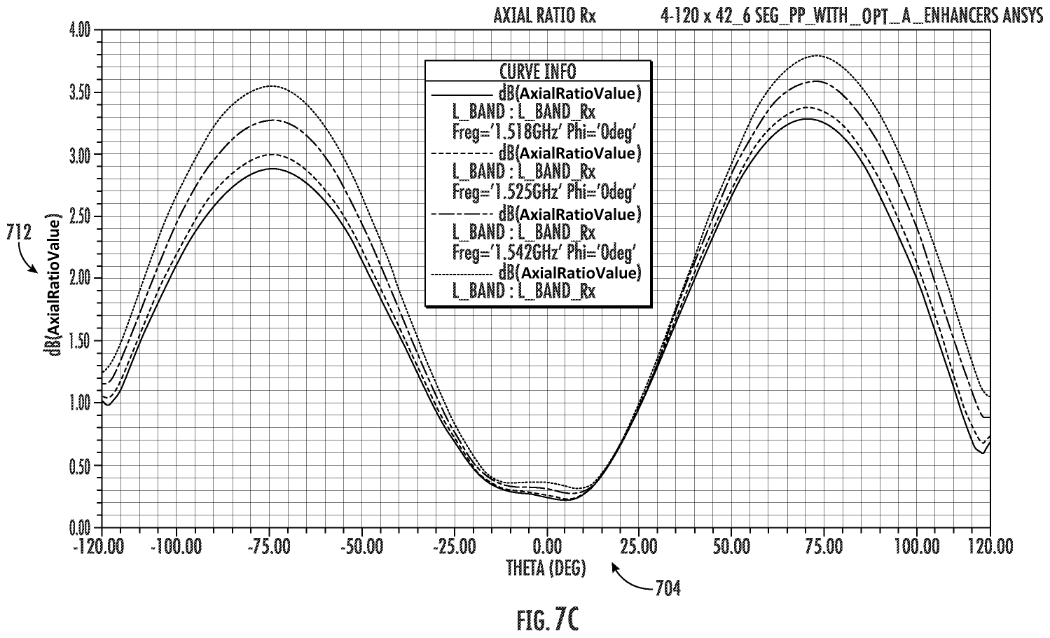

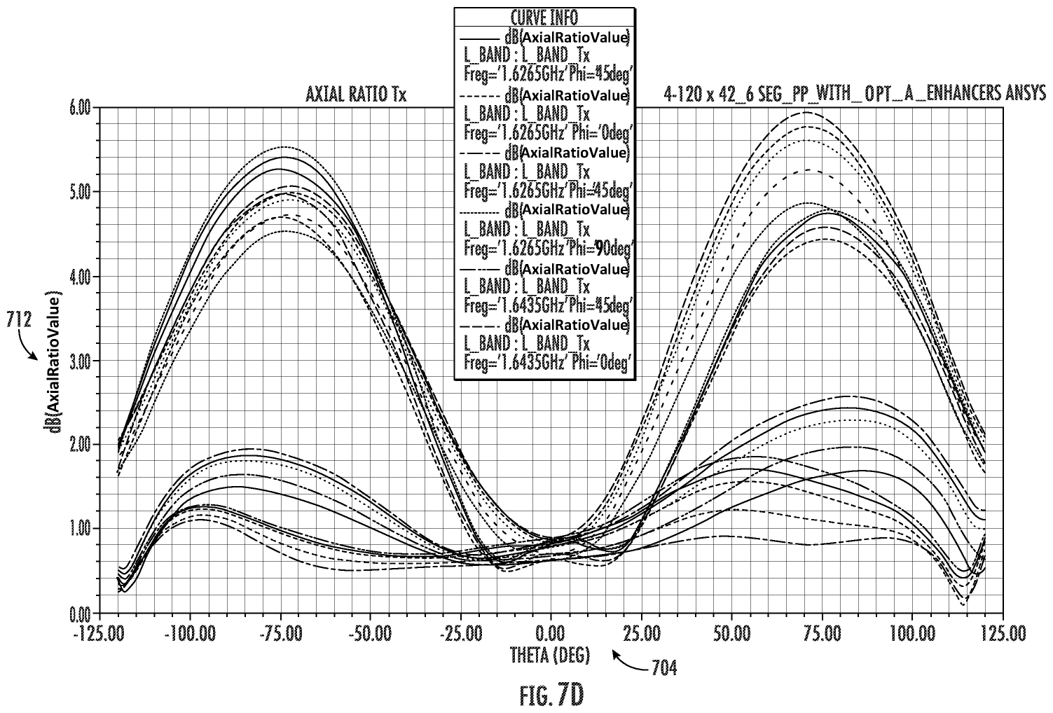

FIG. 7A provides an example plot of an antenna gain in the receive (Rx) band in accordance with at least one example embodiment of the present disclosure. FIG. 7B provides an example plot of an antenna gain in the transmit (Tx) band in accordance with at least one example embodiment of the present disclosure. FIG. 7C provides an example plot of axial ratio in the receive band in accordance with at least one example embodiment of the present disclosure. FIG. 7D provides an example plot of axial ratio in the transmit band in accordance with at least one example embodiment.

Specifically, FIGS. 7A-D provide example plots of antenna gain (in receive band and transmit band respectively) of an antenna having a plurality of beam enhancers comprising metal strips 300 disposed around an axis of the antenna and at least one tuner 500. As shown in FIGS. 7A and 7B, the example antenna gain plots depict the antenna gain represented on the Y-axis 702 in decibel (db) as a function of the elevation angle represented on the on the X-axis 704 in degrees. As shown in FIGS. 7C-7D, the example axial ratio plots depict the axial ratio represented on the Y-axis 712 in decibel (db) as a function of the elevation angle represented on the X-axis 704 in degrees.

As shown in FIGS. 7C-7D, the axial ratio is improved by the tuner (such as tuner 500) as it retunes the example circular polarized antenna. For example, the e-field components difference reduces, which in turn improves the axial ratio. As shown in FIGS. 7A and 7B, the beam width 706 still satisfies the predetermined and/or desired beam width threshold 708.

As will be appreciated, while example embodiments described herein disclose a particular configuration of a circular polarized antenna that includes a plurality of beam enhancers and/or tuner, it would be appreciated that the circular polarized antenna may have a difference configuration. For example, a plurality of beam enhancers comprising a plurality of metal strips 300 may be disposed around any of a plurality of circular polarized antenna configuration, and at least one tuner 500 may be disposed above the circular polarized antenna. For example some embodiments of the present disclosure provide an antenna system, comprising a circular polarized antenna with a plurality of beam enhancers comprising a plurality of non-overlapping metal strips disposed around an axis (e.g., center axis) of the circular polarized antenna, wherein the plurality of non-overlapping metal strips comprises at least a first level of metal strips and at least a second level of metal strips, and wherein the first level of metal strips is vertically offset from the second level of metal strips, and the first level of metal strips is symmetrically arranged around the axis. Additionally, the first level of metal strips are separated by a second offset. In some embodiments, the antenna system comprises at least one tuner disposed above the circular polarized antenna, wherein the tuner comprises a plurality of extending arms symmetrically oriented around the circular polarized antenna, and wherein the plurality of extending arms are formed of a metal material.

### Conclusion

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An antenna system, comprising:
a circular polarized antenna; and
a plurality of beam enhancers, the plurality of beam enhancers comprising a plurality of non-overlapping metal strips disposed around an axis of the circular polarized antenna, wherein:
the plurality of non-overlapping metal strips comprises at least a first level of metal strips and at least a second level of metal strips, wherein the first level of metal strips is vertically offset from the second level of metal strips, and
the first level of metal strips symmetrically arranged around the axis, wherein the first level of metal strips are separated by a second offset.

2. The antenna system of claim 1, wherein each metal strip of the plurality of non-overlapping metal strips has an arc shape.

3. The antenna system of claim 2, wherein the plurality of non-overlapping metal strips have substantially the same arc length.

4. The antenna system of claim 3, wherein the arc length of each metal strip of the plurality of non-overlapping metal strips is determined based on operating wavelength of the circular polarized antenna.

5. The antenna system of claim 1, wherein the plurality of non-overlapping metal strips are disposed on a lower portion of the circular polarized antenna.

6. The antenna system of claim 1, further comprising:
at least one tuner disposed above the circular polarized antenna, wherein the at least one tuner comprises a plurality of extending arms symmetrically oriented around the circular polarized antenna, wherein the plurality of extending arms are formed of a metal material.

7. An antenna system, comprising:
a circular polarized antenna;
a plurality of beam enhancers symmetrically arranged around the circular polarized antenna; and
at least one tuner disposed above the circular polarized antenna, wherein the at least one tuner comprises a plurality of extending arms symmetrically oriented around the circular polarized antenna, wherein the plurality of extending arms are formed of a metal material.

8. The antenna system of claim 7, wherein the plurality of beam enhancers comprise a plurality of non-overlapping metal strips disposed around an axis of the circular polarized antenna.

9. The antenna system of claim 8, wherein each metal strip of the plurality of non-overlapping metal strips has an arc shape.

10. The antenna system of claim 9, wherein the plurality of non-overlapping metal strips have substantially the same arc length.

11. The antenna system of claim 7, wherein the plurality of extending arms radially extend across the antenna system and cause a detuning effect of a body attached to the antenna system.

12. The antenna system of claim 7, wherein the plurality of extending arms define a cross shape.

13. A circular polarized antenna, comprising:
a plurality of antenna elements; and
a plurality of beam enhancers, the plurality of beam enhancers comprising a plurality of non-overlapping metal strips disposed around the plurality of antenna elements wherein:
the plurality of non-overlapping metal strips comprises at least a first level of metal strips and at least a second level of metal strips, wherein the first level of metal strips is vertically offset from the second level of metal strips, and
the first level of metal strips symmetrically arranged around the plurality of antenna elements, wherein the first level of metal strips are separated by a second offset.

14. The circular polarized antenna of claim 13, wherein each metal strip of the plurality of non-overlapping metal strips has an arc shape.

15. The circular polarized antenna of claim 14, wherein the plurality of non-overlapping metal strips have substantially the same arc length.

16. The circular polarized antenna of claim 15, wherein the arc length of each metal strip of the plurality of non-overlapping metal strips is determined based on operating wavelength of the circular polarized antenna.

17. The circular polarized antenna of claim 13, wherein the plurality of non-overlapping metal strips are disposed on a lower portion of the plurality of antenna elements.

18. The circular polarized antenna of claim 13, further comprising:
at least one tuner disposed above the plurality of antenna elements, wherein the at least one tuner comprises a plurality of extending arms symmetrically oriented around the plurality of antenna elements, wherein the plurality of extending arms are formed of a metal.

19. The circular polarized antenna of claim 18, wherein the plurality of extending arms radially extend across the circular polarized antenna and cause a detuning effect of a body attached to the circular polarized antenna.

20. The circular polarized antenna of claim 18, wherein the plurality of extending arms define a cross shape.
